(19) United States
(12) Patent Application Publication
(10) Pub. No.: US 2014/0052728 A1
(43) Pub. Date: Feb. 20, 2014

(54) TEXT CLUSTERING DEVICE, TEXT CLUSTERING METHOD, AND COMPUTER-READABLE RECORDING MEDIUM

(71) Applicants: Satoshi Nakazawa, Tokyo (JP); Takao Kawai, Tokyo (JP); Yuzura Okajima, Tokyo (JP)

(72) Inventors: Satoshi Nakazawa, Tokyo (JP); Takao Kawai, Tokyo (JP); Yuzura Okajima, Tokyo (JP)

(73) Assignee: NEC CORPORATION, Minato-ku, Tokyo (JP)

(21) Appl. No.: 14/114,022

(22) PCT Filed: Mar. 15, 2012
(86) PCT No.: PCT/JP2012/056690

§ 371 Date: Oct. 25, 2013

(30) Foreign Application Priority Data
Apr. 27, 2011 (JP) 2011-098912

(51) Int. Cl. G06F 17/30

(52) U.S. Cl. CPC G06F 17/30598
USPC 707/737

(57) ABSTRACT

A text clustering device (100) is provided with a grouping execution unit (40) that specifies, from among statements that are extracted from texts constituting a text set and contain a set declinable word and subject, combinations of statements that satisfy a set requirement in relation to a specific occurrence, and groups the statements by occurrence, using the specified combinations, and a classification unit (60) that classifies the texts constituting the text set, based on a result of the grouping by the grouping execution unit (40).

### TECHNICAL FIELD

The present invention relates to a text clustering device, a text clustering method, and a computer-readable recording medium storing a program for realizing the device and method, and more particularly to a system of extracting common occurrences included in a set of texts that are targeted for clustering, and clustering the texts according to the extracted occurrences.

### BACKGROUND ART

In recent years, micro blogs made up of comparatively short texts (short sentences) such as Twitter have become popular. Such micro blogs and the like usually contain a large number of texts by numerous commentators describing individual opinions, impressions, related facts and so on concerning specific news, events, incidents and so forth.

Here, the abovementioned news, events, incidents and so forth are collectively referred to in this specification as “occurrences”. An “occurrence” refers to something that someone has done (individual, group or organization) or something that has occurred or taken place.

The numerous texts contained in micro blogs and the like may include texts that are about a common occurrence. In such cases, it is desirable, from a viewpoint of improving readability, to collect the texts by occurrence and distinguish them from other texts.

If the texts can thus be collected by occurrence, this will facilitate specifying texts about a specific occurrence that interests the reader from among a large number of macro blogs or the like.

With CGM (Consumer Generated Media) such as micro blogs and blogs on the Internet, occurrences that are not easily handled as news by conventional mass media and occurrences that have not yet been picked up as news can spread by word-of-mouth and become topical. Accordingly, if this multitude of texts on the Internet can be collected into occurrences that are being commonly written about, this will make it easier to find occurrences that have recently become topical.

On the other hand, conventionally there exist “text clustering techniques” according to which, when a plurality of texts are provided, these plurality of texts are collected into sets (clusters) of similar texts, based on the similarity of statements contained in the texts. Non-patent Document 1 discloses an example of such a text clustering technique.

Accordingly, if the text clustering technique disclosed in Non-patent Document 1 is applied to a large number of micro blogs or the like, distinguishing the micro blogs or the like by occurrence can conceivably be realized. As a result, readers are conveniently able to skip read through micro blogs or the like belonging to clusters in which they are not interested.

### CITATION LIST

### Non-Patent Documents

Non-patent document 1: Masaaki KIKUCHI, Masayuki OKAMOTO, Tomohiro YAMASAKI, “Extraction of topic transition from document stream based on hierarchical clustering”, Data Engineering Workshop (DEWS 2008), B3-3, 2008.

### DISCLOSURE OF THE INVENTION

### Problem to be Solved by the Invention

However, with the text clustering technique disclosed in Non-patent Document 1, texts relating to a common occurrence may not be collected into one cluster, in the case where a set of the comparatively short texts written by a large number of commentators, such as micro blogs, is processed, with this point posing a problem.

This problem arises from the fact that micro blogs and so on differ from conventional Web documents, blogs and so forth in that they are made up of short sentences, and even if there is a text giving an impression or the like about a particular occurrence, it is rare for the original occurrence to be described in sufficient detail in the text itself. In other words, in many cases, with micro blogs and so on, the commentator of a text will only briefly touch on points which he or she judges to be important in his or her description of the original occurrence, and the remaining description will be taken up with the commentator's opinion, impressions or the like.

Hereinafter, this problem will be described with a specific example. Assume, for example, that the following press releases (exemplary occurrence 1) are given as an original occurrence.

### Exemplary Occurrence 1

“The Nanigashi Outdoor Festival will be held in Hokkaido this year.”
“The second line-up for the Nanigashi Festival has now been announced.”
“A total of 39 acts will be coming to Hokkaido, including rock band The Az and pop groups The Bz and The Cz.”

Assume that an exemplary text 1 by a commentator A and an exemplary text 2 by a commentator B are given as comments relating to the exemplary occurrence 1, as shown below.

Exemplary text 1 by commentator A: “No way, the Nanigashi Festival's going to be held in Hokkaido!”
Exemplary text 2 by commentator B: “Rock band The Az are coming to Hokkaido, way to go. Have to find a part-time job and start saving for the trip.”

Someone who is fully aware of the exemplary occurrence 1 will be able to judge from reading these exemplary texts 1 and 2 that they both relate to the exemplary occurrence 1.

However, with the text clustering technique disclosed in Non-patent Document 1, clustering is executed based on the degree of matching and the similarity of the descriptive content between texts, and clustering based on knowledge of the exemplary occurrence 1 is not performed. Therefore, “Hokkaido” will be the only phrase judged to appear commonly in the exemplary text 1 and the exemplary text 2. Also, since the respective impressions and opinions of the commentators are expressed differently in each text, the probability that both texts are matched will be judged to be low with the text clustering technique disclosed in Non-patent Document 1. Accordingly, with the text clustering technique disclosed in Non-patent Document 1, the exemplary text 1 and the exemplary text 2 will be unlikely to be clustered in the same cluster.

As described above, with short texts such as micro blogs, even if the original occurrence is in common, statements relating to the occurrence will not necessarily match. Furthermore, lengthy statements relating to impressions and opinions included in the texts tend to act as text clustering noise. Accordingly, as described above, with the text clustering technique disclosed in Non-patent Document 1, it is difficult to appropriately cluster short texts such as micro blogs.

The present invention solves the abovementioned problems, and has as an object to provide a text clustering device, a text clustering method, and a computer-readable recording medium that enable clustering by occurrence to be executed appropriately, even if the texts that are targeted for clustering consist of short sentences.

### Means for Solving the Problem

In order to attain the above object, a text clustering device according to one aspect of the present invention is a clustering device for performing clustering on a text set, including a grouping execution unit that specifies, from among statements that are extracted from texts constituting the text set and contain a set declinable word and subject, a combination of statements that satisfy a set requirement in relation to a specific occurrence, and groups the statements by occurrence, using the specified combination, and a classification unit that classifies the texts constituting the text set, based on a result of the grouping by the grouping execution unit.

Also, in order to attain the above object, a text clustering method according to one aspect of the present invention is a method for performing clustering on a text set, including the steps of (a) specifying, from among statements that are extracted from texts constituting the text set and contain a set declinable word and subject, a combination of statements that satisfy a set requirement in relation to a specific occurrence, and grouping the statements by occurrence, using the specified combination, and (b) classifying the texts constituting the text set, based on a result of the grouping in the step (a).

Furthermore, in order to attain the above object, a computer-readable recording medium according to one aspect of the present invention is a computer-readable recording medium storing a program for perform clustering on a text set by computer, the program including a command for causing the computer to execute the steps of (a) specifying, from among statements that are extracted from texts constituting the text set and contain a set declinable word and subject, a combination of statements that satisfy a set requirement in relation to a specific occurrence, and grouping the statements by occurrence, using the specified combination, and (b) classifying the texts constituting the text set, based on a result of the grouping in the step (a).

### Effects of the Invention

According to the present invention, as described above, clustering by occurrence can be appropriately executed, even if the texts that are targeted for clustering consist of short sentences.

### BRIEF DESCRIPTION OF DRAWINGS

FIG. 1 is a block diagram showing a configuration of the text clustering device according to an embodiment of the present invention.

FIG. 2 is a diagram showing an exemplary text set that is targeted for text clustering processing in the embodiment.

FIG. 3 is a diagram showing exemplary results of affinity determination performed on the action/situation statements shown in FIG. 2.

FIG. 4 is a diagram showing an exemplary final result of classification performed on the input text set shown in FIG. 2.

FIG. 5 is a flowchart showing operations of the text clustering device according to the embodiment of the present invention.

FIG. 6 is a block diagram showing an exemplary computer for realizing the text clustering device according to the embodiment of the present invention.

### DESCRIPTION OF EMBODIMENTS

### Embodiments

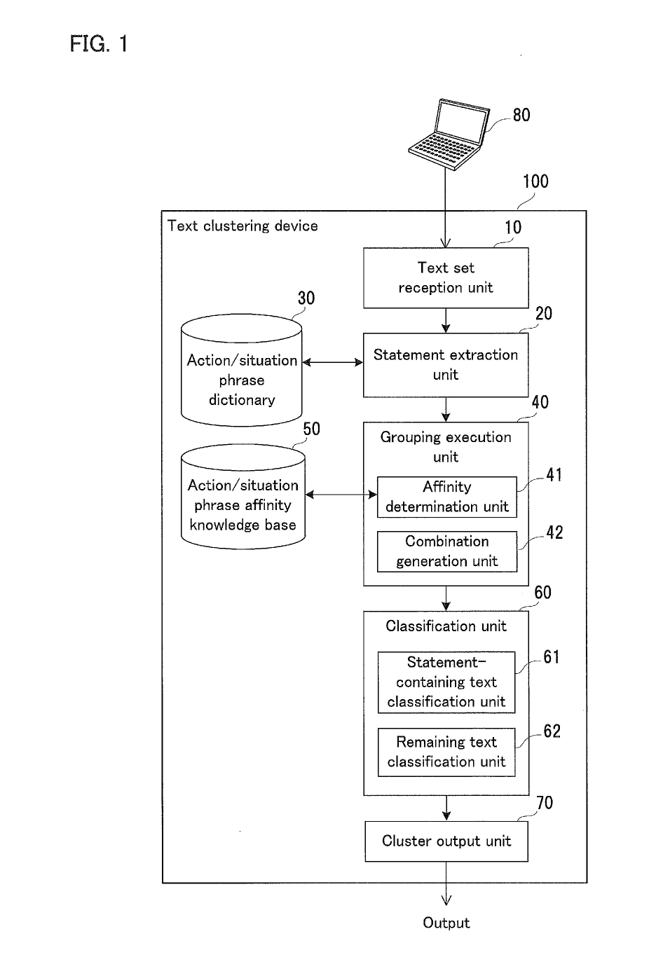

Hereinafter, a text clustering device, a text clustering method and a program according to embodiments of the present invention will be described, with reference to FIGS. 1 to 5.

Device Configuration

Initially, the configuration of a text clustering device 100 according to the present embodiment will be described using FIG. 1. FIG. 1 is a block diagram showing the configuration of the text clustering device according to the embodiment of the present invention.

The text clustering device 100 shown in FIG. 1 is a device that performs clustering on a text set. As shown in FIG. 1, the text clustering device 100 is mainly provided with a grouping execution unit 40 and a classification unit 60.

The grouping execution unit 40 first specifies combinations of statements that satisfy a set requirement in relation to a specific occurrence, from among statements that were extracted from texts constituting a text set and contain set declinable words and subjects. The grouping execution unit 40 then groups the respective statements containing the set declinable words and subjects by occurrence using the specified combinations.

The classification unit 60 classifies the texts constituting the text set, based on the result of the grouping by the grouping execution unit 40. The obtained classification result serves as the text set clustering result.

In this way, with the text clustering device 100 according to the present embodiment, combinations of statements that are in a specific relationship are specified for a given occurrence from a text set, and clustering is performed using each combination. Moreover, the statements used in the combinations contain set declinable words and subjects, and statements that form noise are excluded. The text clustering device 100 according to the present embodiment thus enables clustering by occurrence to be appropriately executed, even if the texts that are targeted for clustering consist of short sentences.

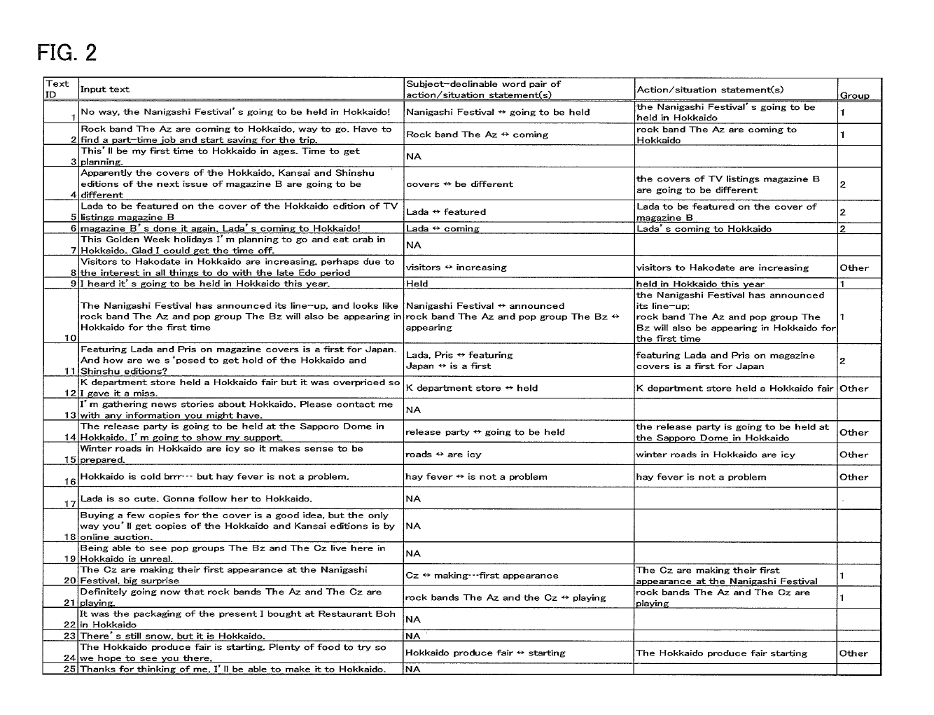

Here, the configuration of the text clustering device 100 according to the present embodiment will be described more specifically using FIGS. 2 to 4 in addition to FIG. 1. As shown in FIG. 1, in addition to the grouping execution unit 40 and the classification unit 60, the text clustering device 100 is provided with a text set reception unit 10, a statement extraction unit 20, an action/situation phrase dictionary 30, an action/situation phrase affinity knowledge base 50, and a cluster output unit 70.

The text set reception unit 10 receives a text set that is targeted for clustering as an input. The text set reception unit 10 receives the text set that is targeted for text clustering from an input device 80, and inputs the received text set to the statement extraction unit 20. Specific examples of the input device 80 include an input device such as a keyboard, a computer connected via a network, and a reading device for reading a recording medium on which the text set is recorded. The input device 80 can be any device capable of inputting text sets. Note that, in FIG. 1, the case where the input device 80 is a computer is illustrated.

In the case where time information such as the transmission date/time and the creation date/time of texts is assigned to the texts constituting the text set whose input was received (hereinafter, “input text set”), it is desirable that the text set reception unit 10 divides the input text set into a plurality of subsets on the basis of the time information assigned to each text. In this case, further improvement in the accuracy of the downstream clustering processing can be anticipated.

At this time, the text set reception unit 10 divides the original input text set so that the time information of the texts belonging to each subset is close. The reason for this is that the transmission dates/times and the creation dates/times of texts written about a common occurrence tend to be close. After the input text set has been divided, subsequent processing is executed as though each subset is an independent input text set.

Note that, in the present embodiment, since the actual clustering processing is the same whether there is one input text set or a plurality of subsets, subsequent description will be given in relation to one input text.

The statement extraction unit 20, in the case where a declinable word is detected from the respective texts constituting the input text set and the detected declinable word is a declinable word that has been set, extracts statements containing the declinable word and the subject thereof. Also, in the present embodiment, the statement extraction unit 20 extracts each statement in a way that associates the statement with the original text.

Here, a “statement” as referred to in the present embodiment includes a statement (hereinafter, “action statement”) in an arbitrary text of something an agent such as an individual, a group, an organization or an animal has done (or will do), and a statement (hereinafter, “situation statement”) in an arbitrary text of something that has occurred (or taken place) such as an incident, a phenomenon, a disaster or an event.

For example, “Cabinet resigned en masse” and “Idol group A held a concert” are exemplary action statements. Also, exemplary situation statements include “There was earthquake that measured 7 on the Richter scale”, “The official discount rate has been reduced”, and “Band B's farewell concert has been announced”. On the other hand, there are phrases that are neither action statements nor situation statements, such as phrases indicating the characteristics of things like “Water freezes at OC”, or phrases that describe opinions or impressions like “Cabinet should not resign en masse in this state of emergency”, “I was disappointed with the curry at D restaurant” or “The movie E was the best I've seen this year”. Note that in subsequent description, “statements” will be described as “action/situation statements”.

In the present embodiment, the determination criteria as to which phrases constitute “action/situation statements” differ according to the application, purpose or the like when clustering is implemented. Specifically, the statement extraction unit 20, in order to determine whether an “action/situation statement” is included in the texts of an input text set, first, performs a morphological analysis and parsing on each text, using well-known natural language processing technology, and detects a declinable word portion in the text.

Next, the statement extraction unit 20 refers to the action/situation phrase dictionary 30, and, using the detected declinable word and if necessary the result of analyzing the surrounding text, determines whether the declinable word is a declinable word that is regarded as an action/situation statement. Note that, as will be discussed later, declinable words that are regarded as action/situation statements are registered beforehand in the action/situation phrase dictionary 30.

If the result of the determination indicates that the detected declinable word is a declinable word that is regarded as an action/situation statement, and, furthermore, corresponds to an action statement, the statement extraction unit 20 extracts the agent that performed the action so as to be paired with the declinable word. Also, if the result of the determination indicates that the detected declinable word is a declinable word that is regarded as an action/situation statement, and, furthermore, corresponds to a situation statement, the statement extraction unit 20 extracts the agent representing the situation so as to be paired with the declinable word. In other words, in the case where the detected declinable word is a declinable word that is regarded as an action/situation statement, the statement extraction unit 20 extracts the subject of the declinable word that is regarded as an action/situation statement. Also, the extracted subject is not limited to one word, and may be a phrase constituted by a plurality of words or may itself be a sentence.

Furthermore, the statement extraction unit 20 may, in addition to the subject of a declinable word that is regarded as an action/situation statement, also extract the object and modifier, according to the application and purpose of the text clustering device 100. Also, the statement extraction unit 20 is able to analyze whether the declinable word is negative or positive, the tense, the modality (hearsay, inference, etc.) and the like, using well-known natural language processing technology, such as a parsing technique or a semantic analysis technique, for example, and to further extract statements from texts corresponding to the analysis results.

Among the texts included in the input text set, there are texts from which the subject and/or the object are omitted. The statement extraction unit 20 is, for example, able to infer the subject and/or the object of such texts, using a well-known zero pronoun resolution technique.

In addition, the statement extraction unit 20 does not extract action/situation statements in which the commentator or the author of the text is the subject. For example, although the text “I ate curry last night” is an action statement in which “I” is the subject, because the commentator is the subject, the statement extraction unit 20 does not target this text for extraction. Furthermore, even in the case where an explicit subject is omitted, like “Late for school yesterday”, the statement extraction unit 20 does not extract phrases in which it is inferred that the subject is likewise the commentator (or author) as action/situation statements.

This is because the purpose of the processing by the statement extraction unit 20 is to focus on common occurrences that are written about in a plurality of input texts, and cluster the texts by those occurrences.

For example, the three texts “Cabinet resigned en masse”, “Cabinet has been dissolved”, and “There are news reports today that cabinet has been dissolved” all deal with the common occurrence of “cabinet” which is the subject having “dissolved” or “resigned en masse”.

On the other hand, if an action/situation statement was directly extracted from each of the three texts “Had curry”, “Ended up having the pork cutlet curry” and “Had the curry” by different commentators, it would be “I had curry”. Although appearing to be about a common occurrence, these statements are in fact about three different occurrences by three different commentators who each “had curry”, and no commonality exists.

Accordingly, in order to avoid judging occurrences that are actually different as a common occurrence, the statement extraction unit 20 excludes action/situation statements in which the commentator or the author of the text is the subject from extraction.

FIG. 2 is a diagram showing an exemplary text set that is targeted for text clustering processing in the present embodiment. In addition to the input text set whose input was received by the text set reception unit 10, the subjects and declinable words contained in the texts and the action/situation statements extracted from the texts are also shown in FIG. 2.

Specifically, each text shown in the example of FIG. 2 is a micro blog posted in given fixed period, and includes “Hokkaido”. Furthermore, in the example in FIG. 2, the text set is shown in tabular form, and a different one of the texts belonging to the input text set is shown on each line.

In FIG. 2, the first column “Text ID” shows IDs that are convenient for distinguishing the individual texts, and do not necessarily need to be assigned to each text of the input text set. For example, the text set reception unit 10 is able to assign a text ID to each text for management purposes.

The second column “Input text” shows the contents of the texts. The third column “Subject-declinable word pair of action/situation statement(s)” shows combinations of subjects and declinable words that are included in the texts. Note that if the text does not contain an action/situation statement, this column is set to “NA”.

The fourth column “Action/situation statement(s)” shows action/situation statements extracted from the texts. In the example in FIG. 2, objects and related modifiers are also collectively extracted, in addition to the subjects and declinable words of action/situation statements. Note that the fifth column “Group” will be described when the grouping execution unit 40 is discussed later.

In the present embodiment, the statement extraction unit 20 is also able to extract a plurality of action/situation statements from one text, in the case where the text contains a plurality of action/situation statements. For example, the statement extraction unit 20 has extracted the two action/situation statements “the Nanigashi Festival has announced its line-up” and “rock band The Az and pop group The Bz will also be appearing” from the text having text ID 10 in FIG. 2.

The action/situation phrase dictionary 30 registers declinable words that are regarded as action/situation statements, according to the application and purpose of the text clustering device 100. The statement extraction unit 20, as described above, determines whether statements that are regarded as action/situation statements are included in the texts of the input text set, with reference to the action/situation phrase dictionary 30.

It is also desirable for grammar information contained in a dictionary used in well-known natural language processing technology, such as the types of part of speech and the inflected forms, like “Dictionary Example 1: conjugations of ‘to dissolve”’, for example, to be registered in the dictionary records of the action/situation phrase dictionary 30, in addition to words corresponding to the declinable words.

In the present embodiment, conditions relating to the inflected forms, modality, surrounding text and the like of a declinable word may be added as conditions for regarding a declinable word as an action/situation statement, in addition to the declinable word simply registered in the action/situation phrase dictionary 30. In the case where such conditions are added, the statement extraction unit 20 also checks these conditions, when determining and extracting statements that are regarded as action/situation statements from the texts of an input text set.

The grouping execution unit 40, as described above, groups the action/situation statements extracted from the texts by occurrence. At this time, in the present embodiment, “tentative occurrence statements” are generated by the grouping. The grouping execution unit 40 can also be referred to as a “tentative occurrence statement generation unit”.

Here, “occurrence statements” will be described first. In this specification, an “occurrence statement” is a statement describing the contents of an “occurrence” as defined in the abovementioned “Background Art”. For example, when the occurrence is a robbery, the following statements released as news of the robbery are occurrence statements of the robbery.

Occurrence Statements of Robbery:

“A robbery occurred at A jewelry store in Shibuya Center Gai.”
“The robber left the store after putting cash from the register into a black bag.”
“After leaving the store, the robber fled towards Harajuku in a white station wagon.”

As further exemplary occurrence statements, the following three statements describing Occurrence Example 1 in the abovementioned “Problem to be Solved by the Invention” are direct examples of occurrence statements of Occurrence Example 1.

Occurrence Statements of Occurrence Example 1:

“The Nanigashi Outdoor Festival will be held in Hokkaido this year.”
“The second line-up for the Nanigashi Festival has now been announced.”
“A total of 39 acts will be coming to Hokkaido, including rock band The Az and pop groups The Bz and The Cz.”

Furthermore, suppose that news (Occurrence Example 2) is released that TV listings magazine B is going to feature a different heroine of a popular video game on the cover of each of its regional editions as part of a tie-up with the video game. In this case, the following occurrence statements of Occurrence Example 2 are given as further exemplary occurrence statements.

Occurrence Statements of Occurrence Example 2:

“The covers of the Hokkaido, Kansai and Shinshu editions of the next issue of TV listings magazine B are going to be different for the different regions.”
“The covers of the regional editions will each feature a different heroine of the popular video game LP.”
“Lada is planned for the Hokkaido edition, Nakiko for the Kansai edition, and Pris for the Shinshu edition.”

Hereinafter, “tentative occurrence statements” will be described next. There are cases where a plurality of commentators and authors of texts respectively create texts about a common occurrence. The purpose of the text clustering device 100 is to extract texts relating to such common occurrences from a large number of texts by occurrence, and collect together and cluster the texts.

Assuming that it were possible to obtain occurrence statements of an occurrence written about as a common topic by a plurality of commentators and authors, the above purpose can be attained by sorting out and collecting together statements similar to the occurrence statements or statements in common with the occurrence statements from an input text set. However, it is generally extremely difficult to obtain occurrence statements of an occurrence that is a common topic from an input text set that is targeted for clustering, before clustering has been performed.

On the other hand, it can be expected that statements whose contents match a portion of the original occurrence statements will be included in the texts constituting an input text set. For example, the text having text ID 1 shown in FIG. 2 includes the action/situation statement “the Nanigashi Festival's going to be held in Hokkaido”, this being an action/situation statement whose contents substantially match the first of the occurrence statements of Occurrence Example 1.

In other words, there is a high possibility that action/situation statements extracted by the statement extraction unit 20 will match a portion of the occurrence statements, and as a result it can be assumed that the action/situation statements belonging to the groups created by the grouping execution unit 40 will be the “occurrence statements” of the corresponding occurrence in their entirety. The occurrence statements thus assumed are “tentative occurrence statements”, and the “tentative occurrence statements” are, as described above, generated by grouping.

In the present embodiment, as shown in FIG. 1, the grouping execution unit 40 is provided with an affinity determination unit 41 and a combination generation unit 42, in order to generate “tentative occurrence statements” from the action/situation statements extracted from an input text set.

The affinity determination unit 41 determines, for every combination of two action/situation statements, the affinity between the two action/situation statements based on a preset rule, and, if the determination result indicates that the affinity satisfies set criteria, specifies the combination as a combination that satisfies the set requirement. Also, the combination generation unit 42 executes grouping by collecting the specified combinations, so that, in each group, the action/situation statements belonging to the group are not mutually contradictory and relate to a common occurrence (i.e., so that the action/situation statements are a series of statements describing a common occurrence). Hereinafter, the affinity determination unit 41 and the combination generation unit 42 will each be specifically described. First, the affinity determination unit 41 will be described.

For example, in the example in FIG. 2, action/situation statements have been extracted from the 16 texts whose “Action/situation statement(s)” column is not empty, out of the 25 texts (text IDs 1 to 25). Therefore, the affinity determination unit 41, targeting these 16 action/situation statements, determines the affinity between arbitrary pairs of action/situation statements, such as the affinity between the action/situation statement having text ID 1 and the action/situation statement having text ID 2.

Note that a plurality of action/situation statements can be extracted from one text as in the case of text ID 10, and in such cases the affinity determination unit 41 determines that the “affinity is high” between all action/situation statements extracted from the same text.

The affinity determination unit 41, in the case of determining the affinity between a plurality of action/situation statements extracted from one text and an action/situation statement extracted from another text, determines the affinity for each of the plurality of action/situation statements. In other words, the affinity determination unit 41, for example, determines the affinity between the action/situation statement having text ID 1 and the first action/situation statement having text ID 10, and further determines the affinity between the action/situation statement having text ID 1 and the second action/situation statement having text ID 10.

As described above, given that the combination generation unit 42 performs grouping so as to form a series of statements that are not mutually contradictory and describe the one occurrence, the affinity determination unit 41 performs the determination using the following affinity determination rules as criteria for determining affinity.

Furthermore, in the present embodiment, the affinity determination unit 41 is able to perform binary determination according to which the action/situation statements are determined to have “high affinity” or “no affinity”. The affinity determination unit 41 is also able to assign a score representing the level of affinity between two action/situation statements based on the affinity determination rules, and ultimately determine that two action/situation statements having a level of affinity exceeding a threshold have a “high affinity”. Note that it is desirable to determine what technique to use in the determination and what value to set as the threshold for the affinity determination in the case of calculating the level of affinity beforehand, according to the purpose, application or the like of the text clustering device 100.

### Affinity Determination Rules

Rules 1 to 6 are given as exemplary affinity determination rules.

### Rule 1: Matching of Subjects

Any two action/situation statements having matching subjects will be determined to have a high affinity. In the case where the subjects include a plurality of agents (e.g., “Mr. A and Mr. B”, etc.), action/situation statements will be determined to have a high affinity, on condition of a portion of one subject matching a portion of the other subject. In the case where the affinity is calculated rather than being determined binarily, partial matching of subjects is given a lower level of affinity than full matching.

The level of affinity may be incremented in the case where there are not only matching subjects but where the matching of declinable words, modifiers and objects is also investigated and any of these are matched. For example, if the degree to which declinable words that are different from each other appear together in a series of statements is derived beforehand, the level of affinity is incremented with respect to declinable words (e.g., “holding a press conference”, “making an announcement”, etc) whose degree of appearing together is high. In contrast, the level of affinity is decremented with respect to declinable words whose degree of appearing together in statements describing one occurrence is low.

Note that, in the present embodiment, the combinations of declinable words that increase the degree to which declinable words appear together in a series of statements describing one occurrence is recorded in the action/situation phrase affinity knowledge base 50 discussed later.

### Rule 2: Matching of Subject and Object

In general linguistic phrases, there are ways of expressing A actively as a subject and passively as an object, when describing the action or situation of the same agent A. Therefore, similarly to Rule 1, it is determined according to Rule 2 that two action/situation statements also have a high affinity in the case where the subject and the object are matched. According to Rule 2, the level of affinity or the like may also be calculated similarly to Rule 1.

Rule 3: Matching of Declinable Words when Subject is Omitted or Unknown

In the case where the subject of either or both of two action/situation statements is unknown due to being omitted or the like, whether or not the “affinity is high” is determined according to the matching of declinable words. Also, the level of affinity may be incremented, in the case where there are not only matching declinable words but where the matching of modifiers and objects is also investigated and any of these are matched.

Rule 4: Exclusion of Case where Declinable Words Matched Between Different Subjects

In the case where the declinable words of two action/situation statements are matched but the subjects are not matched, it is determined that there is no affinity, since there are different agents that are doing the same thing.

### Rule 5: Extension of Conditions for Matching of Subject and Object

Agents or things that are listed together in texts included in the input text set, such as “A, B and C”, “three groups such as A, B and C participated”, “A, B or C”, “also A and B”, are equated with each other for the purposes of clustering the input text set, and matching is determined according to the other rules.

For example, two action/situation statements such as “A called the meeting to order” and “B called the meeting to order” are mutually exclusive according to Rule 4, and would be judged to have no affinity. However, if a text like “Cooperation between A and B means . . . ” exists in the input text set, A and B are equated with each other according to Rule 5. Thereby, the two action/situation statements “A called the meeting to order” and “B called the meeting to order” are judged to have a high affinity according to Rule 1, since the subjects and the declinable words are matched.

### Rule 6: Matching of Time Conditions, Place Conditions and Means Conditions in Modifiers

In the case where two action/situation statements both contain modifiers, a time condition (e.g.: “on March 15”), a place condition (e.g.: “in Hokkaido”) or a means condition (e.g.: “negotiate with the agency”) is extracted from each modifier, using a well-known information extraction technique. Then, in the case where a time condition, a place condition or a means condition is included in each modifier, whether or not the affinity is high is determined based on the degree of matching between the conditions, or the level of affinity is scored.

Note that the abovementioned affinity determination rules are merely examples of affinity determination rules that can be used in the present embodiment, and all of the abovementioned affinity determination rules need not necessarily be applied. In the present embodiment, some or all of the abovementioned affinity determination rules may be used in combination, according to the application, purpose or the like of the text clustering device 100.

In order to respond to the problem of there being a plurality of phrases indicating the same agent or thing (problem of variant spelling) or the problem of variations in phraseology, the affinity determination unit 41 may normalize the phrases of action/situation statements, either before or at the time of determining affinity, by applying well-known synonym processing and quasi-synonym processing techniques.

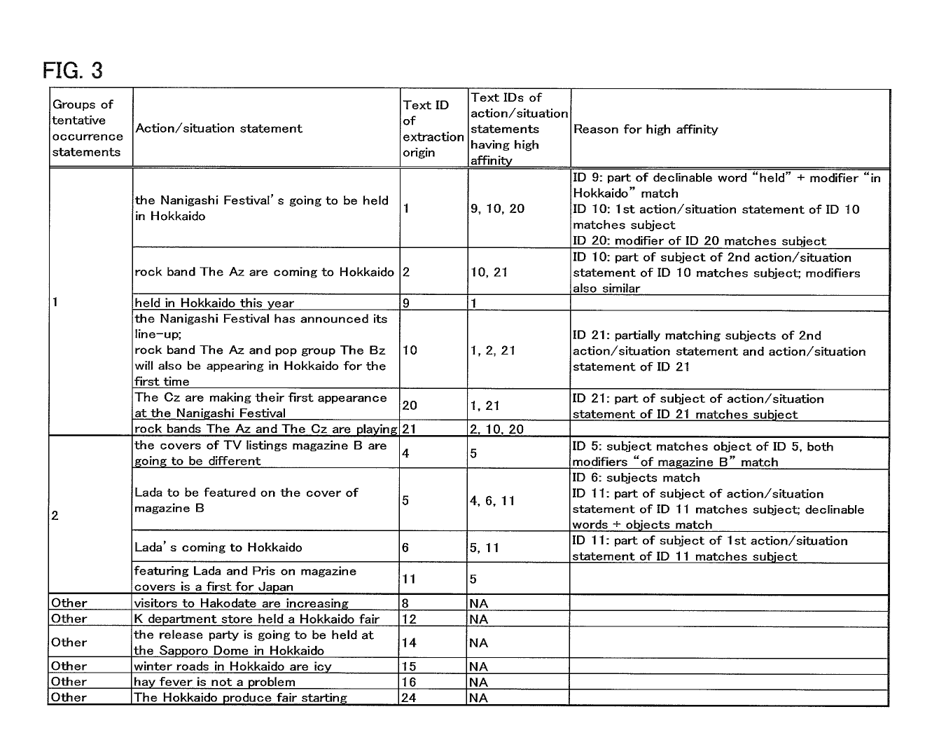

Here, the results of affinity determination based on the affinity determination rules will be described using FIG. 3. FIG. 3 is a diagram showing exemplary results of affinity determination performed on the action/situation statements shown in FIG. 2. In FIG. 3, the abovementioned affinity determination rules have been applied to each combination of the action/situation statements shown in FIG. 2.

Specifically, in the fourth column “Text IDs of action/situation statements having high affinity” in FIG. 3 are stored the text IDs of the texts from which action/situation statements having a high affinity with the action/situation statements of the respective lines were extracted. “NA” in the field of the “Text IDs of action/situation statements having high affinity” column indicates that there are no action/situation statements having a high affinity with the action/situation statement of that line. In the column “Reason for affinity” is stored the reason for each determination (reason for the affinity being high).

The combination generation unit 42 receives the results of the affinity determination by the affinity determination unit 41, and generates groups of tentative occurrence statements by transitively linking the action/situation statements that are determined to have a high affinity. The combination generation unit 42 directly outputs the generated groups of tentative occurrence statements as the output of the grouping execution unit 40.

Here, the action/situation statement of each line is denoted by the text ID of the text from which the action/situation statement was extracted. In the example in FIG. 3, based on the affinity determination results, ID 1 is linked to IDs 9, 10 and 20, ID 10 is linked to IDs 2 and 21, and so on in order. In the example in FIG. 3, ultimately a group 1 of tentative occurrence statements constituted by IDs 1, 2, 9, 10, and 21, and a group 2 of tentative occurrence statements constituted by IDs 4, 5, 6 and 11 are generated.

On the other hand, IDs 8, 12, 14, 15, 16 and 24 constitute independent action/situation statements, and do not constitute a group with other action/situation statements. The independent action/situation statements may be handled individually, or may be constituted as a special group that collects these independent action/situation statements as “other” or the like.

The action/situation phrase affinity knowledge base 50 records information that is used when the grouping execution unit 40 (or the affinity determination unit 41) determines the affinity between two action/situation statements. Specifically, such information includes the size of the increment in the level of affinity preset for each condition, affinity determination rules, and the like.

The classification unit 60 is, in the present embodiment, provided with a statement-containing text classification unit 61 and a remaining text classification unit 62. Of these, the statement-containing text classification unit 61 sets a class for each group generated by the grouping execution unit 40. The statement-containing text classification unit 61 then classifies each text from which an action/situation statement was extracted, among the texts contained in the input text set, into the class set for the group to which that action/situation statement belongs.

Specifically, the statement-containing text classification unit 61 is able to perform classification by regarding each of the groups that are generated by the grouping execution unit 40 as one class. In this case, the statement-containing text classification unit 61 specifies the action/situation statements belonging to each group, and classifies the texts from which the specified action/situation statements were extracted into classes that correspond one-to-one with the groups.

A specific example will be described using the input text set shown in FIGS. 2 and 3. First, it is assumed that the grouping execution unit 40 has generated three groups shown in FIG. 3, namely, groups 1 and 2 of tentative occurrence statements and an “other” group. In this case, the statement-containing text classification unit 61 generates three classes respectively corresponding to the groups, and classifies the texts from which action/situation statements were extracted into the classes.

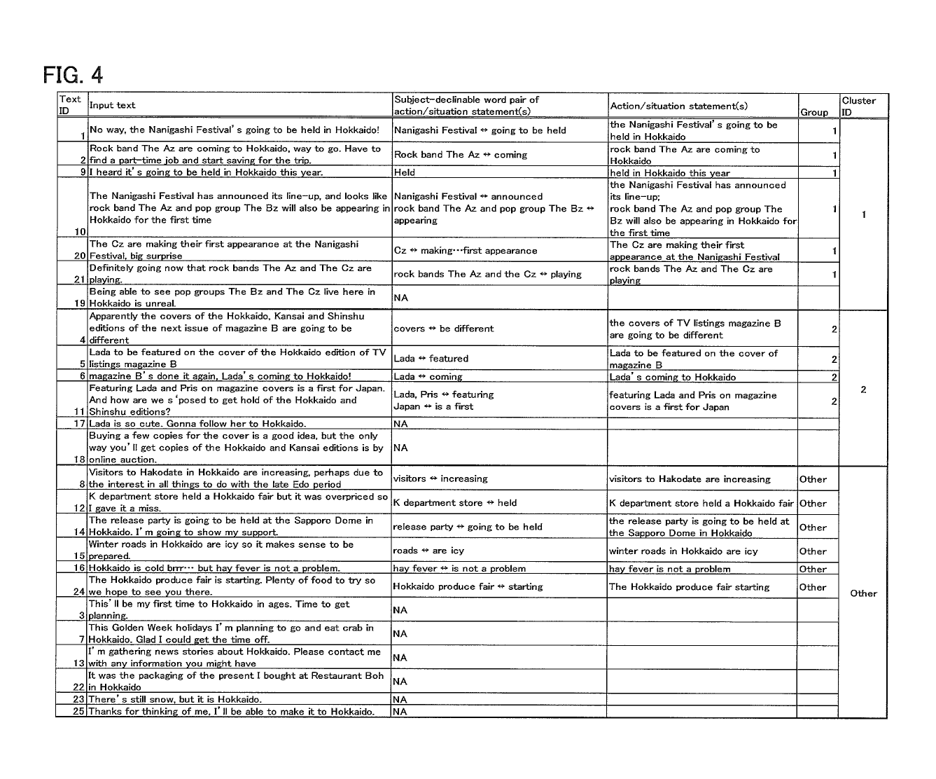

Taking the text having text ID 1 shown in FIG. 2 as an example, this text contains the action/situation statement “the Nanigashi Festival's going to be held in Hokkaido”, with this action/situation statement belonging to group 1 of tentative occurrence statements. Therefore, the statement-containing text classification unit 61 classifies the text having text ID 1 into the class (cluster ID 1: see FIG. 4) corresponding to group 1. Note that the result of classifying each input text is shown in the sixth column “cluster ID” of the table in FIG. 4.

The remaining text classification unit 62 specifies texts from which an action/situation statement was not extracted by the statement extraction unit 20, and classifies each of the specified texts into one of the classes set by the statement-containing text classification unit 61 or into a new class. The remaining text classification unit 62 is also able to perform classification by regarding each of the groups that are generated by the grouping execution unit 40 as one class, similarly to the statement-containing text classification unit 61.

A specific example will be described using the input text set shown in FIGS. 2 and 3. In the example in FIG. 2, the texts of lines in which the field of the third column “Subject-declinable word pair of action/situation statement(s)” is “NA” correspond to texts that were determined not to include an action/situation statement by the statement extraction unit 20. Hereinafter, such texts that do not include an action/situation statement will be described as “remaining texts”.

First, the remaining text classification unit 62 calculates, for each remaining text, the similarity with texts that have already been classified by the statement-containing text classification unit 61. The remaining text classification unit 62 then classifies the targeted remaining text into the class in which the text having the highest similarity is classified.

For example, the text having text ID 19 shown in FIG. 2 includes a phrase matching phrases in the texts having text IDs 10, 20 and 21 classified into the class (cluster ID 1) corresponding to group 1. The remaining text classification unit 62 thus classifies the text having text ID 19 into the class (cluster ID 1) corresponding to group 1.

Determining the similarity between remaining texts and texts that have already been classified can be performed by using existing natural language processing technology such as an inter-text similarity determination technique that is used in clustering techniques or the like, for example. Specifically, the similarity determination to be used is preferably decided beforehand, according to the application and purpose of the text clustering device 100 of the present embodiment.

Furthermore, although the remaining text classification unit 62 classifies the targeted remaining text into the class in which the text with the highest similarity is classified in the above description, the present embodiment is not limited thereto. The remaining text classification unit 62 is also able to generate a new class for the targeted remaining text, in the case where the similarity between the remaining text and the texts that have already been classified is lower than a preset threshold in all classes.

Classification of remaining texts will be described using FIG. 4. FIG. 4 is a diagram showing an exemplary final result of classification performed on the input text set shown in FIG. 2. As described above, since the texts including action/situation statements have already been classified by the statement-containing text classification unit 61, all the texts constituting the input text set will have been classified by the processing of the remaining text classification unit 62. In FIG. 4, the final classification result is stored in the “Cluster ID” column on the far right.

Note that, in this specification, the phrase “classification” is used to describe the processing of the statement-containing text classification unit 61 and the remaining text classification unit 62. This is because, after groups have been generated by the grouping execution unit 40, the texts of the input text set are classified into the groups, and thus it is appropriate to use “classification”, following on from usage of the term in existing natural language processing technology.

In the present embodiment, the groups of tentative occurrence statements are not defined in advance but are dynamically generated according to the input text set. The processing performed in the present embodiment is thus equivalent to “clustering”.

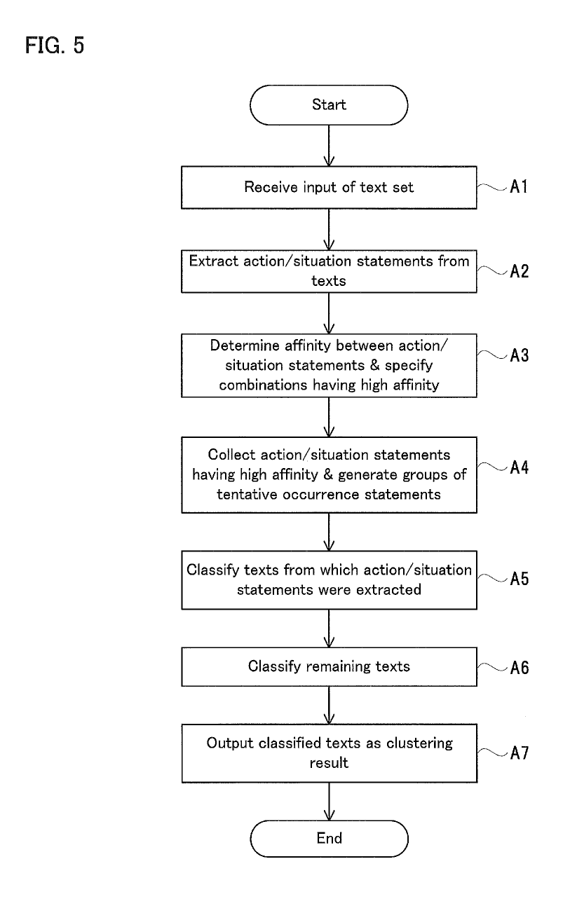

The cluster output unit 70 outputs the classification result as the result of clustering the input text set. In the present embodiment, the cluster output unit 70 receives the final classification result (see FIG. 5) that is output by the remaining text classification unit 62, and outputs the received result as the result of clustering performed on the input text set.

### Operations of Device

Next, operations of the text clustering device 100 according to the embodiment of the present invention will be described using FIG. 5. FIG. 5 is a flowchart showing operations of the text clustering device according to the embodiment of the present invention. In the following description, FIGS. 1 to 4 are referred to as appropriate. Also, in the present embodiment, the text clustering method is implemented by operating the text clustering device 100. Therefore, description of the text clustering method according to the present embodiment is replaced with the following description of the operations of the text clustering device 100.

As shown in FIG. 5, first, the text set reception unit 10 receives input of a text set that is targeted for clustering from the input device 80 (step A1). Also, in step A1, the text set reception unit 10 inputs the received input text set to the statement extraction unit 20.

Next, the statement extraction unit 20 extracts action/situation statements from the texts constituting the input text set (step A2). At step A2, the statement extraction unit 20 extracts each action/situation statement in a manner such that the action/situation statement is associated with the original text, as shown in FIG. 2. The statement extraction unit 20 also extracts pairs of declinable words and subjects from the texts.

Next, the affinity determination unit 41 determines, for each combination of two action/situation statements, the affinity between the two action/situation statements, targeting the action/situation statements extracted at step A2, and specifies combinations having a high affinity from the determination results (step A3). Specifically, at step A3, the affinity determination unit 41 determines the affinity based on the affinity determination rules recorded in the action/situation phrase affinity knowledge base 50.

Next, the combination generation unit 42 generates groups of tentative occurrence statements, using the combinations of action/situation statements having a high affinity (step A4). At step A4, the combination generation unit 42 inputs information specifying the generated groups to the classification unit 60.

Next, the statement-containing text classification unit 61 sets a class for each group created at step A4, and classifies each text, in the input text set, from which an action/situation statement was extracted into the class set for the group to which the action/situation statement belongs (step A5).

Next, the remaining text classification unit 62 specifies, from among the texts included in the input text set, texts from which an action/situation statement was not extracted, that is, remaining texts, and classifies the specified remaining texts into a class set at step A5 or into a new class (step A6). Specifically, at step A5, the remaining text classification unit 62 calculates the similarity of each remaining text with the texts that were classified at step A5, and classifies the remaining text based on the calculated similarity.

Finally, the cluster output unit 70 outputs the texts classified in step A5 and step A6 as the result of clustering performed on the input text set (step A7). The processing of the text clustering device 100 ends with the execution of step A7.

As described above, the text clustering device 100 according to the present embodiment specifies combinations of action/situation statements having a high affinity from a text set, links each combination with common action/situation statements, and performs clustering using the result of this processing. Also, the text clustering device 100 excludes any statement in the texts that does not show a specific occurrence as noise. According to the text clustering device 100 of the present embodiment, clustering by occurrence is thus appropriately executed, even if the texts that are targeted for clustering consist of short sentences as in the case of mini blogs.

### Program

A program according to the present embodiment can be any program that causes a computer to execute steps A1 to A7 shown in FIG. 5. The text clustering device 100 and the text clustering method of the present embodiment can be realized by installing this program on a computer and executing the installed program. In this case, a CPU (Central Processing Unit) of the computer functions as the text set reception unit 10, the statement extraction unit 20, the grouping execution unit 40, the classification unit 60 and the cluster output unit 70, and performs the processing thereof.

In the present embodiment, the action/situation phrase dictionary 30 and the action/situation phrase affinity knowledge base 50 can be realized by storing data files constituting the dictionary and the knowledge base in a storage device such as a hard disk provided in a computer.

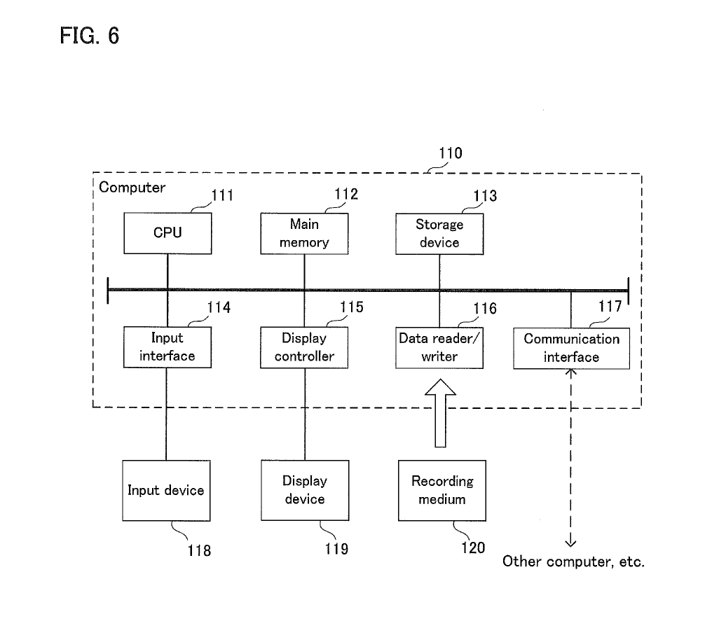

Here, a computer 110 that realizes the text clustering device 100 by executing the program according to the embodiment will be described using FIG. 6. FIG. 6 is a block diagram showing an exemplary computer that realizes the text clustering device according to the embodiment of the present invention.

As shown in FIG. 6, the computer 110 is provided with a CPU 111, a main memory 112, a storage device 113, an input interface 114, a display controller 115, a data reader/writer 116, and a communication interface 117. These units are connected to each other via a bus 121 in a manner that enables data communication.

The CPU 111 implements various arithmetic operations, by expanding the program (codes) according to the present embodiment that is stored in the storage device 113 in the main memory 112, and executing these codes in a predetermined order. Typically, the main memory 112 is a volatile storage device such as a DRAM (Dynamic Random Access Memory). Also, the program according to the present embodiment is provided in a state of being stored on a computer-readable recording medium 120. Note that the program according to the present embodiment may also be distributed over the Internet connected via the communication interface 117.

Specific examples of the storage device 113, apart from a hard disk, include a semiconductor memory device such as a flash memory. The input interface 114 mediates data transmission between the CPU 111 and an input device 118 such as a keyboard and a mouse. The display controller 115 is connected to a display device 119 and controls display performed on the display device 119.

The data reader/writer 116 mediates data transmission between the CPU 111 and the recording medium 120, and executes reading of programs from the recording medium 120, and writing of the results of processing by the computer 110 to the recording medium 120. The communication interface 117 mediates data transmission between the CPU 111 and other computers.

Specific examples of the recording medium 120 include a general-purpose semiconductor memory device such as a CF (Compact Flash (registered trademark)) or SD (Secure Digital) card, a magnetic storage medium such as a flexible disk, or optical storage medium such as a CD-ROM (Compact Disk Read Only Memory).

Although part or all of the abovementioned embodiment can be realized by notes 1 to 15 described below, the embodiment is not limited to the following description.

### Note 1

A clustering device for performing clustering on a text set, comprising:

a grouping execution unit that specifies, from among statements that are extracted from texts constituting the text set and contain a set declinable word and subject, a combination of statements that satisfy a set requirement in relation to a specific occurrence, and groups the statements by occurrence, using the specified combination; and

a classification unit that classifies the texts constituting the text set, based on a result of the grouping by the grouping execution unit.

### Note 2

The text clustering device according to note 1, further comprising:

a statement extraction unit that detects a declinable word from each text constituting the text set, and, if the detected declinable word is the set declinable word, extracts a statement containing the declinable word and a subject of the declinable word.

### Note 3

The text clustering device according to note 1 or 2,

wherein the grouping execution unit executes the grouping by determining, for each combination of two statements, an affinity between the two statements based on a preset rule, specifying the combination as a combination that satisfies the set requirement if the affinity satisfies a set criterion, and collecting, in each group, the specified combinations so that the statements belonging to the group are not mutually contradictory and are related to a common occurrence.

### Note 4

The text clustering device according to note 2,

wherein the classification unit includes:

a first classification unit that sets a class for each group, and classifies the text from which each statement was extracted into the class set for the group to which the statement belongs; and

a second classification unit that specifies a text from which a statement was not extracted by the statement extraction unit, and classifies the specified text into one of the classes set by the first classification unit or into a new class.

### Note 5

The text clustering device according to note 4,

wherein the second classification unit derives, for each specified text, a similarity between the specified text and each text classified into a class that was set by the first classification unit, and executes classification based on the derived similarities.

### Note 6

A method for performing clustering on a text set, comprising the steps of:

(a) specifying, from among statements that are extracted from texts constituting the text set and contain a set declinable word and subject, a combination of statements that satisfy a set requirement in relation to a specific occurrence, and grouping the statements by occurrence, using the specified combination; and

(b) classifying the texts constituting the text set, based on a result of the grouping in the step (a).

### Note 7

The text clustering method according to note 6, further comprising the step of:

(c) detecting a declinable word from each text constituting the text set, and, if the detected declinable word is the set declinable word, extracting a statement containing the declinable word and a subject of the declinable word.

### Note 8

The text clustering method according to note 6 or 7,

wherein, in the step (a), the grouping is executed by determining, for each combination of two statements, an affinity between the two statements based on a preset rule, specifying the combination as a combination that satisfies the set requirement if the affinity satisfies a set criterion, and collecting, in each group, the specified combinations so that the statements belonging to the group are not mutually contradictory and are related to a common occurrence.

### Note 9

The text clustering method according to note 7, including as the step (b);

a step (b1) of setting a class for each group, and classifying the text from which each statement was extracted into the class set for the group to which the statement belongs; and

a step (b2) of specifying a text from which a statement was not extracted in the step (c), and classifying the specified text into one of the classes set in the step (b1) or into a new class.

### Note 10

The text clustering method according to note 9,

wherein, in the step (b2), for each specified text, a similarity between the specified text and each text classified into a class in the step (b1) is derived, and classification is executed based on the derived similarities.

### Note 11

A computer-readable recording medium storing a program for perform clustering on a text set by computer, the program including a command for causing the computer to execute the steps of

(a) specifying, from among statements that are extracted from texts constituting the text set and contain a set declinable word and subject, a combination of statements that satisfy a set requirement in relation to a specific occurrence, and grouping the statements by occurrence, using the specified combination; and

(b) classifying the texts constituting the text set, based on a result of the grouping in the step (a).

### Note 12

The computer-readable recording medium according to note 11, further comprising the step of

(c) detecting a declinable word from each text constituting the text set, and, if the detected declinable word is the set declinable word, extracting a statement containing the declinable word and a subject of the declinable word.

### Note 13

The computer-readable recording medium according to note 11 or 12,

wherein, in the step (a), the grouping is executed by determining, for each combination of two statements, an affinity between the two statements based on a preset rule, specifying the combination as a combination that satisfies the set requirement if the affinity satisfies a set criterion, and collecting, in each group, the specified combinations so that the statements belonging to the group are not mutually contradictory and are related to a common occurrence.

### Note 14

The computer-readable recording medium according to note 12, including as the step (b):

a step (b1) of setting a class for each group, and classifying the text from which each statement was extracted into the class set for the group to which the statement belongs; and

a step (b2) of specifying a text from which a statement was not extracted in the step (c), and classifying the specified text into one of the classes set in the step (b1) or into a new class.

### Note 15

The computer-readable recording medium according to note 14,

wherein, in the step (b2), for each specified text, a similarity between the specified text and each text classified into a class in the step (b1) is derived, and classification is executed based on the derived similarities.

Although the claimed invention was described above with reference to an embodiment, the claimed invention is not limited to the above embodiment. Those skilled in the art will appreciate that various modifications can be made to the configurations and details of the claimed invention without departing from the scope of the claimed invention.

This application is based upon and claims the benefit of priority of the prior Japanese Patent Application No. 2011-98912 filed on Apr. 27, 2011, the entire contents of which are incorporated herein by reference.

### INDUSTRIAL APPLICABILITY

As described above, according to the present invention, clustering by occurrence can be appropriately executed, even if the texts that are targeted for clustering consist of short sentences. Therefore, the present invention is useful for the purpose of clustering texts on the Internet such as micro blogs, and improving readability. The present invention is also applicable for the purpose of finding a common occurrence that forms the subject of a plurality of texts from among a large number of texts.

### DESCRIPTION OF REFERENCE NUMERALS

10 Text set input unit
20 Statement extraction unit
30 Action/situation statement phrase dictionary
40 Grouping execution unit
41 Affinity determination unit
42 Group generation unit
50 Action/situation phrase affinity knowledge base
60 Classification unit
61 Statement-containing text classification unit
62 Remaining text classification unit
70 Cluster output unit
100 Text clustering device
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. A clustering device for performing clustering on a text set, comprising:
a grouping execution unit that specifies, from among statements that are extracted from texts constituting the text set and contain a set declinable word and subject, a combination of statements that satisfy a set requirement in relation to a specific occurrence, and groups the statements by occurrence, using the specified combination; and
a classification unit that classifies the texts constituting the text set, based on a result of the grouping by the grouping execution unit.

2. The text clustering device according to claim 1, further comprising:
a statement extraction unit that detects a declinable word from each text constituting the text set, and, if the detected declinable word is the set declinable word, extracts a statement containing the declinable word and a subject of the declinable word.

3. The text clustering device according to claim 1,
wherein the grouping execution unit executes the grouping by determining, for each combination of two statements, an affinity between the two statements based on a preset rule, specifying the combination as a combination that satisfies the set requirement if the affinity satisfies a set criterion, and collecting, in each group, the specified combinations so that the statements belonging to the group are not mutually contradictory and are related to a common occurrence.

4. The text clustering device according to claim 2,
wherein the classification unit includes:
a first classification unit that sets a class for each group, and classifies the text from which each statement was extracted into the class set for the group to which the statement belongs; and
a second classification unit that specifies a text from which a statement was not extracted by the statement extraction unit, and classifies the specified text into one of the classes set by the first classification unit or into a new class.

5. The text clustering device according to claim 4,
wherein the second classification unit derives, for each specified text, a similarity between the specified text and each text classified into a class that was set by the first classification unit, and executes classification based on the derived similarities.

6. A method for performing clustering on a text set, comprising the steps of:
(a) specifying, from among statements that are extracted from texts constituting the text set and contain a set declinable word and subject, a combination of statements that satisfy a set requirement in relation to a specific occurrence, and grouping the statements by occurrence, using the specified combination; and
(b) classifying the texts constituting the text set, based on a result of the grouping in the step (a).

7. A computer-readable recording medium storing a program for perform clustering on a text set by computer, the program including a command for causing the computer to execute the steps of:
(a) specifying, from among statements that are extracted from texts constituting the text set and contain a set declinable word and subject, a combination of statements that satisfy a set requirement in relation to a specific occurrence, and grouping the statements by occurrence, using the specified combination; and
(b) classifying the texts constituting the text set, based on a result of the grouping in the step (a).

8. The text clustering method according to claim 6, further comprising the step of:
(c) detecting a declinable word from each text constituting the text set, and, if the detected declinable word is the set declinable word, extracting a statement containing the declinable word and a subject of the declinable word.

9. The text clustering method according to claim 6,
wherein, in the step (a), the grouping is executed by determining, for each combination of two statements, an affinity between the two statements based on a preset rule, specifying the combination as a combination that satisfies the set requirement if the affinity satisfies a set criterion, and collecting, in each group, the specified combinations so that the statements belonging to the group are not mutually contradictory and are related to a common occurrence.

10. The text clustering method according to claim 8, including as the step (b):
a step (b1) of setting a class for each group, and classifying the text from which each statement was extracted into the class set for the group to which the statement belongs; and
a step (b2) of specifying a text from which a statement was not extracted in the step (c), and classifying the specified text into one of the classes set in the step (b1) or into a new class.

11. The text clustering method according to claim 10,
wherein, in the step (b2), for each specified text, a similarity between the specified text and each text classified into a class in the step (b1) is derived, and classification is executed based on the derived similarities.

12. The computer-readable recording medium according to claim 7, further comprising the step of:
(c) detecting a declinable word from each text constituting the text set, and, if the detected declinable word is the set declinable word, extracting a statement containing the declinable word and a subject of the declinable word.

13. The computer-readable recording medium according to claim 7,
wherein, in the step (a), the grouping is executed by determining, for each combination of two statements, an affinity between the two statements based on a preset rule, specifying the combination as a combination that satisfies the set requirement if the affinity satisfies a set criterion, and collecting, in each group, the specified combinations so that the statements belonging to the group are not mutually contradictory and are related to a common occurrence.

14. The computer-readable recording medium according to claim 12, including as the step (b):
a step (b1) of setting a class for each group, and classifying the text from which each statement was extracted into the class set for the group to which the statement belongs; and
a step (b2) of specifying a text from which a statement was not extracted in the step (c), and classifying the specified text into one of the classes set in the step (b1) or into a new class.

15. The computer-readable recording medium according to claim 14,
wherein, in the step (b2), for each specified text, a similarity between the specified text and each text classified into a class in the step (b1) is derived, and classification is executed based on the derived similarities.
